(19) United States
(12) Patent Application Publication
(10) Pub. No.: US 2018/0250682 A1
(43) Pub. Date: Sep. 6, 2018

(54) A METHOD AND SYSTEM FOR PREPARING BATCHES OF MATERIAL

(71) Applicant: NEWCASTLE INNOVATION LIMITED, Callaghan, New South Wales (AU)

(72) Inventors: William Moreau Palmer, Callaghan (AU); Antony Paul Martin, Callaghan (AU); Christopher William Brown, Callaghan (AU); Christopher Grof, Callaghan (AU)

(21) Appl. No.: 15/755,405

(22) PCT Filed: Aug. 29, 2016
(86) PCT No.: PCT/AU2016/050810

§ 371 Date: Feb. 26, 2018

(30) Foreign Application Priority Data
Aug. 27, 2015 (AU) 2015903477

(51) Int. Cl. B02C 17/10; B02C 17/18; B02C 17/20; G01N 1/44; G01N 1/42

(52) U.S. Cl. CPC B02C 17/10; B02C 17/1815; G01N 2001/2866; G01N 1/44; G01N 1/42; B02C 17/20

(57) ABSTRACT

The present invention provides a method for preparing two or more batches of material. A first batch is placed into a first container and a second batch is placed into a second container. A grinding media is added to each of the first and second containers. The first and second containers are placed into a movable body, which is moved to induce movement of the first and second containers at least under gravitational force in the movable body so that the grinding media grind the first and second batches inside their respective first and second containers. A system is also provided.

### FIELD OF THE INVENTION

The present invention relates to a method and system for preparing batches of material and in particular a method and system for preparing samples, especially for use in laboratory testing. The invention has been developed primarily for use with the preparation of biological samples for testing in laboratories and will be hereinafter described within reference to this application. However, it will be appreciated that the invention is also applicable to the grinding of other materials and/or the preparation of samples composed of other materials, including organic material, animal-based material, plant-based material, food, pharmaceutical substances, chemical substances like paint, inorganic material like mineral ore, glass, metal, plastic, ceramic and other substances that require testing, processing or consumption in a consumer, industrial, commercial and/or laboratory environment.

### BACKGROUND OF THE INVENTION

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Compositional, chemical and physical testing of samples typically requires the samples to be suitably prepared. This often involves reducing the sample in size to enable testing instruments to obtain useful results from the sample. This reduction of sample size is commonly performed by using a simple grinding apparatus, such as a ball mill grinder or a knife mill. A ball mill grinder uses grinding media in the form of steel or ceramic balls to crush the sample within a rotating drum. A knife mill uses a set of knives or blades that rotate within a drum to cut up the sample into a smaller size. All these commonly used grinding apparatuses are limited in that a single sample is processed at any one time. This means that it can take a long time to process multiple samples unless multiple grinding apparatuses are used, which increases costs. In addition, it is necessary to thoroughly clean the grinding apparatus after each sample is processed to prevent contamination of subsequent samples, especially when different types of samples are being processed. This can be labour intensive, especially when the grinding media must also be thoroughly cleaned, reducing the available time for technical staff to conduct testing and other tasks. Knife mills also tend to result in some loss of the sample due to the cutting action involved. Grinding methods can also vary in their effectiveness at complete homogenisation of a sample (i.e. ground sample being composed of particles having the same size). This is reflected in the particle size and particle size distribution measurements within each sample.

### SUMMARY OF THE INVENTION

It is an object of the present invention to overcome or substantially ameliorate one or more of the disadvantages of prior art, or at least to provide a useful alternative. It is an object of the present invention in at least one embodiment to provide a method and system for preparing multiple samples simultaneously for testing.

According to a first aspect the present invention provides a method for preparing two or more batches of material, comprising placing a first batch into a first container and placing a second batch into a second container; adding a grinding media in each of said first and second containers; and moving said first and second containers so that said grinding media grind said first and second batches inside their respective first and second containers.

Preferably, comprising placing said first and second containers into a holding container, elevating said first and second containers from said holding container and permitting said first and second containers to fall back into said holding container to subject said first and second containers to a gravitational force to cause grinding of said first and second batches.

Preferably, said movable body comprises a rotatable body and said moving step comprises rotating said rotatable body to induce rotation of said first and second containers in said rotatable body.

Preferably, the method comprises removing said first and second containers from said movable body.

Preferably, the method comprises removing said grinding media from said first and second containers. More preferably, said grinding media comprises a ferrous material and said method comprises using a magnetic force to remove said grinding media from said first and second containers. In one preferred form, the grinding media comprises a ferrous core. In another preferred form, the grinding media comprises entirely of ferrous material. In this preferred form, the ferrous material is homogenous throughout the grinding media,

Preferably, said grinding media comprises at least two different types of grinding media to enhance grinding of said first and second batches.

Preferably, the method comprises retaining said first and second batches in said first and second containers for subsequent processing. More preferably, said subsequent processing comprises at least one of transportation of said first and second batches, storage of said first and second batches and testing said first and second batches.

Preferably, the method comprises drying said first and second batches prior to placement in said movable body. More preferably, said first and second batches are dried after placement into said first and second containers. In one embodiment, said first and second containers are sealed after drying. In some embodiments, said drying of said first and second batches occurs at a temperature of around 40° C. to 100° C. In other embodiments, said first and second batches are subjected to freeze drying or other drying methods.

Preferably, the method comprises placing said movable body in a low temperature environment. More preferably, said low temperature environment is between 5° C. and −200° C. In one embodiment, said low temperature environment is between −40° C. and −60° C. In some embodiments, said movable body is placed within a low temperature chamber.

Preferably, said first and second batches comprise the same substance. Alternatively, said first and second batches comprise different substances. In one embodiment, said first and second batches comprise an organic or biological material. The organic or biological material may comprise a biomass, plant material, animal material, animal tissue, microbiological material, genetic material (animal or plant based), food, organic chemical or pharmaceutical substance. In other embodiments, said first and second batches comprise an inorganic material. The inorganic material may comprise a mineral ore, rock metal, plastic, glass, ceramic or inorganic chemical. In further embodiments, one or more batches may comprise a mixture of organic and inorganic materials.

Preferably, there is a plurality of batches, wherein each batch is placed into a separate container.

Preferably, said batches comprise samples of said material. In one embodiment, the samples are for use in testing said material.

According to a second aspect the present invention provides a method for preparing two or more samples, comprising placing a first sample into a first container and placing a second sample into a second container; adding a grinding media in each of said first and second containers; placing said first and second containers into a rotatable body; and rotating said rotatable body to induce rotation of said first and second containers in said rotatable body so that said grinding media grind said first and second samples inside their respective first and second containers.

This second aspect of the invention may also have the preferred features of the first aspect of the invention as described above.

A third aspect of the present invention provides the use of two or more containers in the method of the first aspect or second aspect of the present invention.

Preferably, said containers comprise a re-sealable lid. In one embodiment, said re-sealable lid comprises a cap.

Preferably, said containers are cylindrical in shape. In some embodiments, said containers are circular, rectangular, square, oval, hexagonal, octagonal or other polygonal shape.

Preferably, said containers comprise an impact resistant material. More preferably, said containers comprise a material resistant to extremes in temperature. In one embodiment, said containers comprise a heat resistant material. In some embodiments, said containers comprise a cold resistant material. In further embodiments, said containers comprise a heat and cold resistant material. In one particular embodiment, said containers comprise a polycarbonate material.

According to a fourth aspect of the present invention there is provided a system for preparing two or more batches, comprising two or more containers for receiving said batches and a grinding media, a movable body for receiving said containers, a drive mechanism for moving said movable body to induce movement of said containers under at least gravitational force so that said grinding media grind said batches inside said containers.

Preferably, said movable body comprises a rotatable body and said drive mechanism is operable to rotate said rotatable body to induce rotation of said containers.

Preferably, said drive mechanism comprises a drive shaft connected to said rotatable body and a drive means for rotating said drive shaft. More preferably, said driver comprises a motor operatively connected to a drive chain that is operatively connected to said drive shaft.

Preferably, said system further comprises a chamber for receiving said movable body, wherein said chamber is configured to produce a low temperature environment around said movable body.

Preferably, said system comprises a heating device for heating said containers prior to placement into said movable body. More preferably, said heating device comprises at least one of an oven, furnace and heating chamber.

According to a fifth aspect of the present invention there is provided a system for preparing two or more samples, comprising two or more containers for receiving said samples and a grinding media, a rotatable body for receiving said containers, a drive mechanism for rotating said rotatable body to induce rotation of said containers so that said grinding media grind said samples inside said containers.

This fifth aspect of the invention may also have the preferred features of the fourth aspect of the invention as described above.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a schematic drawing illustrating a method according to one embodiment of the invention;

FIG. 2 is a side view of a container for use in the method of FIG. 1;

FIG. 3 is a cross-sectional view of a grinding apparatus for use in the method of FIG. 1;

FIG. 4 is a perspective view of a grinding apparatus according to another embodiment of the invention;

FIG. 5 is a plan view illustrating examples of ground samples and the container of FIG. 2;

FIGS. 6A to 6C are magnified views of samples prepared by the method of FIG. 1 and samples obtained using conventional techniques;

FIG. 7 is a graph comparing test results obtained from samples of FIGS. 6A to 6C;

FIGS. 8A to 8F are column charts comparing the method of FIG. 1 and samples obtained using conventional techniques;

FIG. 9 is a side view of a grinding apparatus according to a further embodiment of the invention;

FIG. 10 is a an end view of the grinding apparatus of FIG. 9; and

FIG. 11 is a cross-sectional view of part of the grinding apparatus of FIG. 9.

### PREFERRED EMBODIMENTS OF THE INVENTION

The present invention will now be described with reference to the following examples which should be considered in all respects as illustrative and non-restrictive. In particular, the following examples are described in the context of applying the invention to the preparation of two or more samples for testing, but it will be appreciated that the invention is capable of application more generally to the preparation of batches of material for other purposes, such as consumption by an end consumer, processing or consumer or use in an industrial process to produce an end product. In the Figures, corresponding features within the same embodiment or common to different embodiments have been given the same reference numerals.

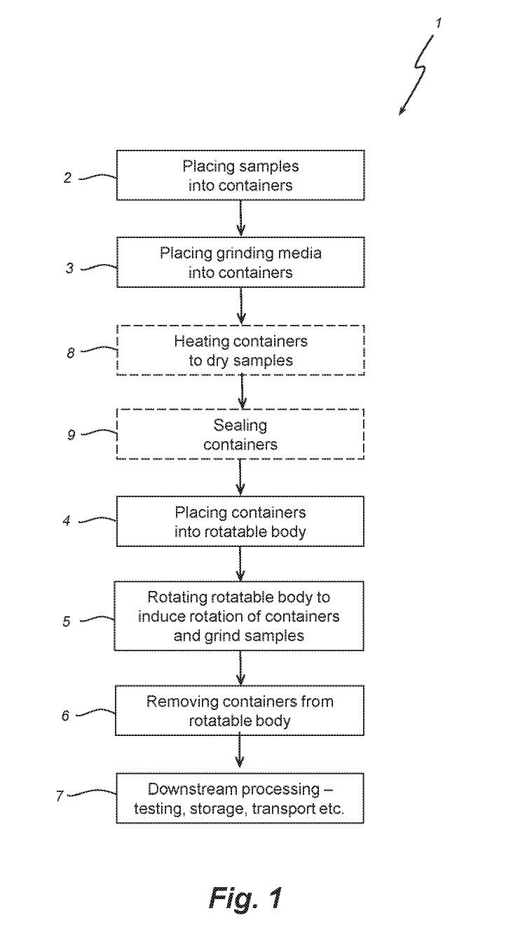

FIG. 1 schematically illustrates a method 1 in one implementation of the invention for preparing two or more batches in the form of samples for testing, such as in a laboratory. For ease of illustration, the method 1 will be described with reference to two samples, but it will be appreciated that the method is equally applicable to multiple samples or batches. In the method 1, a first sample is placed into a first container and a second sample is placed into a second container at step 2. Grinding media is then added into each of the containers at step 3. It will be appreciated that steps 2 and 3 are interchangeable; that is, the grinding media may be placed into the first and second containers prior to the first and second samples. At step 4, the containers are placed into a rotatable body and then at step 5, the rotatable body is rotated, inducing a rotation of the containers so that the grinding media grind said first and second samples inside their respective first and second containers. That is, the rotation of the rotatable body creates a “tumbling” action in the containers, as well as the grinding media in the containers. This results not only in rotation, but also lifting up the containers and so subjecting them to a gravitational force. This combination of forces results in the grinding media moving within the first and second containers to grind the samples therein. At step 6, once the first and second samples have been ground into particulate form at the desired particle size, the rotatable body is stopped and the containers are removed for downstream processing at step 7, which can include testing of the now crushed samples immediately, storage of the samples in the containers for later testing or transport of the samples in the containers to another facility to conduct tests on the samples. It will be appreciated that a combination of these downstream processing steps may be performed, such as for example storing the samples in the containers and transporting the containers to another facility at a later date.

Optionally, the samples may also be dried prior to grinding at step 8, where dried samples are preferred or required for testing. Drying of the samples is preferably done when the samples are inside open containers to allow any heated gases to escape, prior to placing the containers inside the rotatable body at step 4. However, the drying of the samples may be performed with the containers closed, if desired. Heating of the containers is performed by using an oven, furnace, heating chamber or other heating device to dry the samples. Typically, the samples are heated at a temperature of 40° C. to 100° C., preferably 70° C., to be dried, although other temperatures can be used depending on the nature of the sample material. Also, other drying methods may be used, such as freeze drying. Once the samples are ready, the containers are removed and can be immediately sealed at step 9 to keep the sample in a vacuum environment. This minimises contamination of the samples after drying and avoids double handling of the samples before testing.

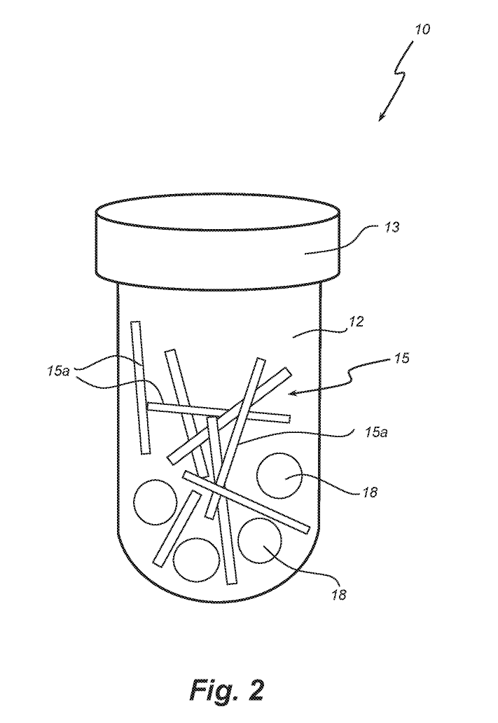

Referring to FIG. 2, a container 10 used in embodiments of the invention is illustrated, comprising a vial having a container body 12 and a resealable lid in the form of a cap 13. A sample 15 comprising multiple components 15a is placed with the container 10 with suitable grinding media 18. The containers 10 are impact resistant and in this embodiment are preferably made from polycarbonate material. Moreover, the polycarbonate containers 10 are also heat resistant, enabling the containers to be used in the sample drying steps 8 and 9. In other embodiments, the containers 10 are made of other impact resistant or durable materials, such as other plastics and metals that are heat, cold and/or impact resistant. Thus, the containers 10 are resistant to extremes in temperature (hot and cold) to permit both pre-drying of the samples 15 and/or preparation of the samples 15 in a cold environment. The grinding media 18 in this embodiment comprises stainless steel balls, but other types of grinding media may be used, such as ceramic balls. The grinding media 18 is preferably chemically inert to avoid contamination of the sample 15.

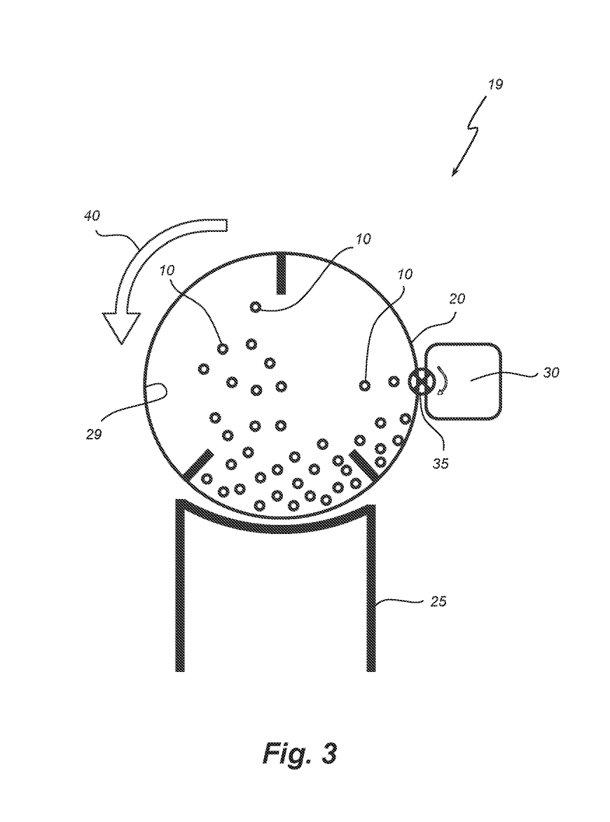

Referring to FIG. 3, an apparatus 19 for grinding the samples 15 is illustrated, which in combination with the containers 10 form a system according to one embodiment of the invention. The apparatus 19 comprises a rotatable body in the form of a drum 20 mounted on a stand 25. The drum 20 has rubber agitator blades or vanes 28 for facilitating rotation of the containers 10 within the drum 20 and a rubber lining 29 on its inner surface to protect the drum from damage caused by impacts from the containers during rotation. A motor 30 rotates the drum 20 via a drive mechanism 35 in the direction indicated by arrow 40. This rotation induces rotation of the containers 10 within the drum 20, causing the grinding media 18 within each container 10 to grind the samples 15. After rotating the drum 20 for a predetermined period, the samples 15 have been ground into particulate form by the grinding media 18 within their respective containers 10. The containers 10 are then removed from the rotatable drum 20 and the grinding media 18 is removed physically. Where the sample 15 has been pre-dried, any sample residue on the grinding media 18 simply falls off. The ground samples 15 in the containers 10 can then be used for downstream processing, either used immediately in testing the samples 15 or kept in storage for future use, testing or transport to another location (laboratory or facility) to perform testing of the samples. In addition, the containers 10 can be easily labelled or engraved with the appropriate identifying information to assist in storage and/or transport of the samples 15.

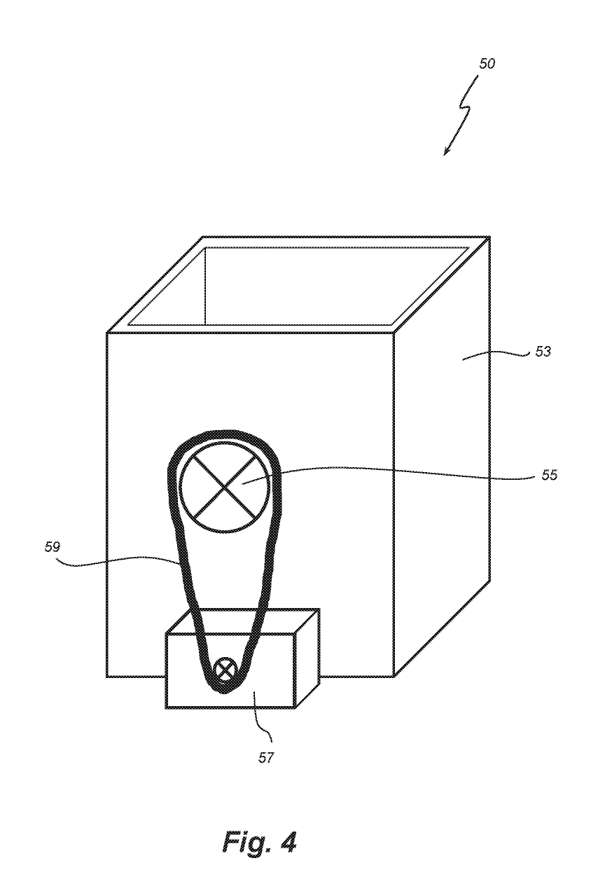

Another embodiment of the invention is illustrated in FIG. 4, where the system uses a grinding apparatus 50 comprising a chamber 53 into which the drum 20 located. A drive shaft 55 for rotating the drum 20 is connected to a motor 57 via a drive chain 59. The chamber 53 is configured to create a controlled low temperature environment to prepare samples 15 that require to be cooled before testing. The chamber 53 can lower the temperature surrounding the drum 20 from 5° C. to −200° C., preferably −20° C. to −170° C. and most preferably from −40° C. to −60° C., either using a refrigerant system (not shown) associated with the chamber 53 and/or placing dry ice around the drum 20 in the chamber 53. Where lower temperatures approaching −170° C. are required, liquid nitrogen may be added into the chamber 53 around the drum 20.

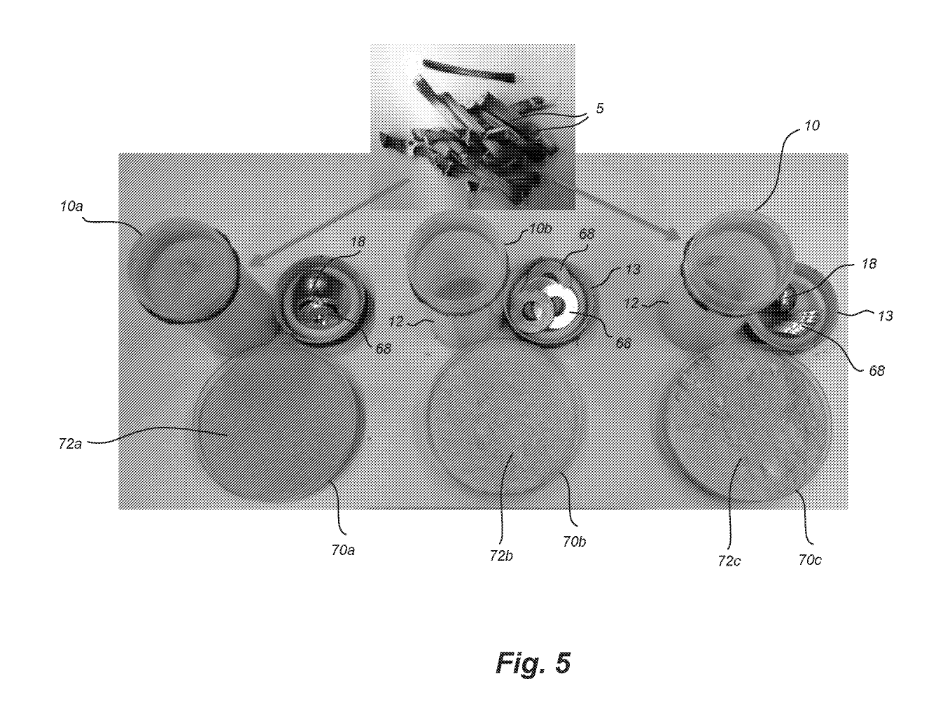

FIG. 5 illustrates examples of ground samples 15 obtained using the method 1. In FIG. 5, the sample 15 comprises plant material that has been placed in containers 10 that have different types of grinding media 18, 68. In container 10a, the grinding media comprises both stainless steel balls 18 and annular discs 68. In container 10b, the grinding media comprises only annular discs 68. In container 10c, the grinding media comprises both stainless steel balls 18 and stainless steel annular discs 68, where the number of annular discs is greater than the number of annular discs in container 10a. The dishes 70a to 70c show the resulting ground samples 72a to 72c for each container 10a to 10c. The resultant finer-sized particle distribution for the ground samples 15 leads to more accurate test results, especially for more sensitive testing equipment. It will be appreciated that other types of grinding media may be used in combination in a similar manner to the described embodiment as still achieve similar results.

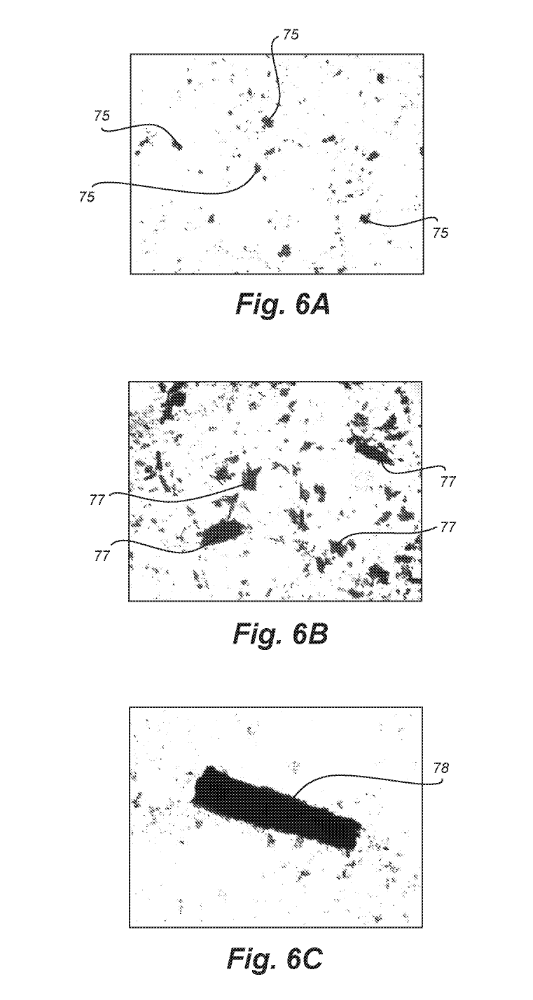

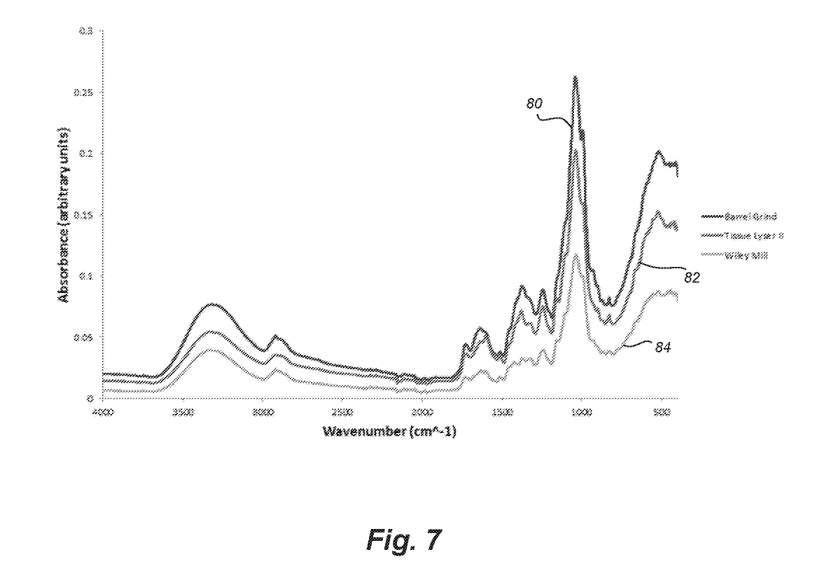

Referring to FIGS. 6A, 6B, 6C and 7, a comparison of the particle size of a sample ground using the method 1 and grinding apparatus 19 according to the embodiments of the invention was made against the particle sizes of samples ground by two other grinding techniques—TissueLyser II (which involves high speed shaking of the sample in a container with a grinding media) and a traditional knife mill. FIG. 6A shows an image taken of the particles in a sample ground by the method 1 and grinding apparatus 19 according to the embodiments of the invention, FIG. 6B shows an image taken of the particles in a sample ground by the TissueLyser II technique and FIG. 6C shows an image taken of the particles in a sample ground by the knife mill. As shown by these Figures, the particles 75 for the sample ground by the method 1 and grinding apparatus 19 according to the embodiments of the invention is much smaller in size (i.e. diameter) compared to the particles 77 for the TissueLyser II technique and even more smaller compared to the particles 78 for the sample ground by the knife mill. FIG. 7 shows a graph of an FT-MIR (Fourier transform mid infrared) spectra is shown, which compares the results obtained from samples prepared by the embodiments of the invention, TissueLyser II and the knife mill. As shown in line 80, the samples obtained by grinding method 1 give the highest signal compared to the other two grinding techniques, and therefore the best signal to noise ratio. Compared to the TissueLyser II technique shown in line 82, there is a 30% increase in signal while compared to the knife mill there is a 125% increase in the signal. Since the TissueLyser II technique produces finer sized particles compared to the knife mill and the method 1 produces the smallest particle size for the samples, the inventors contemplate that the signal (accuracy of a test result) correlates very strongly with particle size. Thus, the method 1 produces the smallest particle size and hence gives the highest signal. This means that more accurate results can be obtained using samples prepared according to the method 1 of the embodiments of the invention.

The inventors have also conducted a comparative analysis of dried samples prepared by the method 1 of embodiments of the invention (referred to as a “drum grinder”), the TissueLyser II, knife mill and a planetary ball mill, as set out in Tables 1 to 3 below.

TABLE 1
Comparative Analysis of Grinding Efficiency

| Grinding Method | Grinding time (min) | Number of samples per batch |
|---|---|---|
| Drum grinder | 1440 | 1000 |
| TissueLyser II | 5 | 2 |
| Planetary ball mill | 60 | 1 |
| Knife mill | 2 | 1 |

As indicated by Table 1 above, the embodiments of the invention are able to produce a significantly greater number of samples compared to the other grinding techniques (1000 samples compared to 1 or 2 samples). While the grinding time appears longer for the embodiments of the invention, when compared against the equivalent time required by the other grinding techniques to produce the same number of samples, the embodiments of the invention in fact is more time efficient.

TABLE 2
Comparative Analysis of Cost and Labour

| | Maintenance | Labour per | | |
|---|---|---|---|---|
| | costs per | batch | Labour per | |
| Grinding | 10,000 | (min) | sample (min | Cost per |
| Method | samples | See table 1 | per sample) | sample ($) |
| Drum grinder | $100 | 60 | 0.06 | 0.5 |
| TissueLyser II | $2,188 | 15 | 7.5 | 3.7 |
| Planetary ball | $2,000 | 80 | 15 | 5.5 |
| mill | | | | |
| Knife mill | $1000 | 2 | 2 | 1.2 |

As indicated by Table 2 above, the samples made in accordance with the invention incur lower costs (both in set up, maintenance and production). In particular, maintenance costs are lower by a factor of at least 10. The associated labour of technical staff in preparing the samples according to embodiments of the invention is also much lower in terms of time spent, compared to the other grinding techniques. This overall leads to a much lower production cost per sample for the embodiments of the invention compared to the other grinding techniques.

TABLE 3
Comparative Analysis of Particle Size

| | Average | Standard | Standard | |
|---|---|---|---|---|
| | particle | deviation | deviation in | Range of |
| | size from | between | particle size | particle sizes |
| | biological | biological | within a | within a |
| | reps | reps | sample | sample |
| Grinding Method | (μm²) | (μm²) | (μm²) | (μm²) |
| Drum grinder | 235 | 33 | 665 | 5 to 19,312 |
| TissueLyser II | 342 | 37 | 2150 | 5 to 199,659 |
| Planetary ball mill | 644 | 112 | 1432 | 5 to 23,978 |
| Knife mill | 882 | 251 | 11625 | 5 to 535,302 |

As indicated by Table 3 above, the embodiments of the invention are able to produce a smaller particle size that is more uniform or homogenous, as indicated by the low standard deviations in the biological reps and particle size, and the narrower range of particle sizes. It will be appreciated that the term “biological reps” means that different plant material in the samples prepared by all the grinding methods. This means that the same source material was not used for each sample but different materials were used so that the samples were sufficient variable to test each of the grinding methods over different materials and calculate the overall particle size obtained from using those grinding methods. Thus, the prepared samples are able to produce more accurate results and minimise aberrant results caused by abnormally large particles present in the sample.

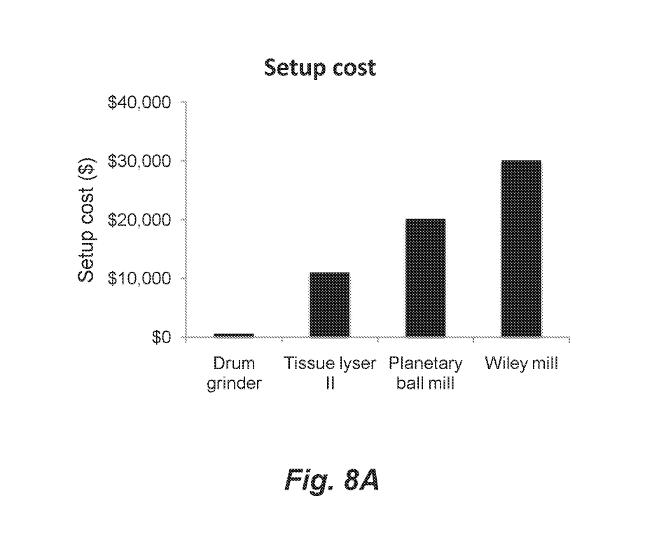

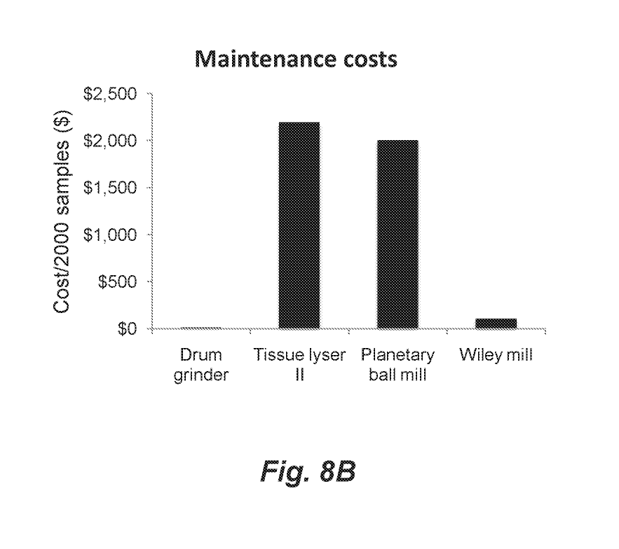

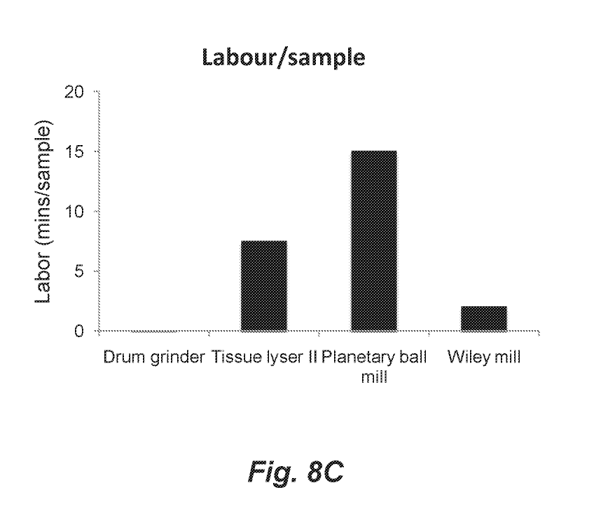

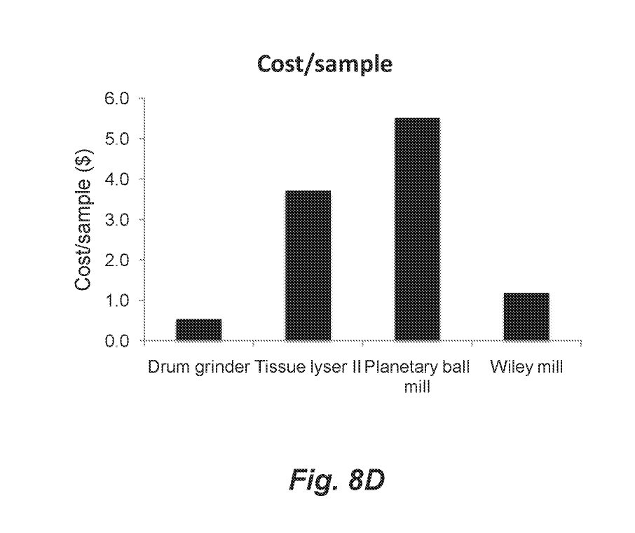

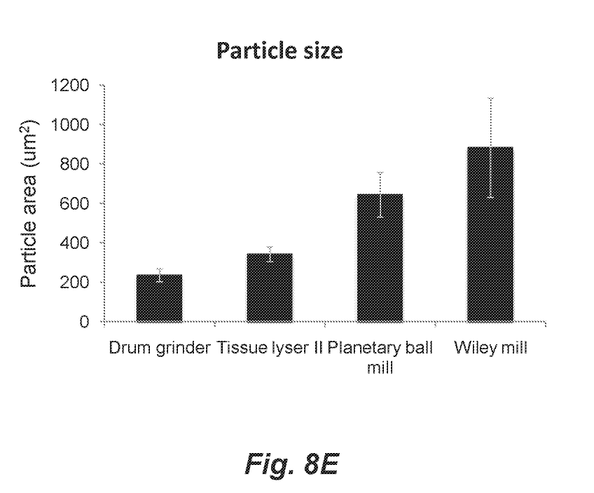

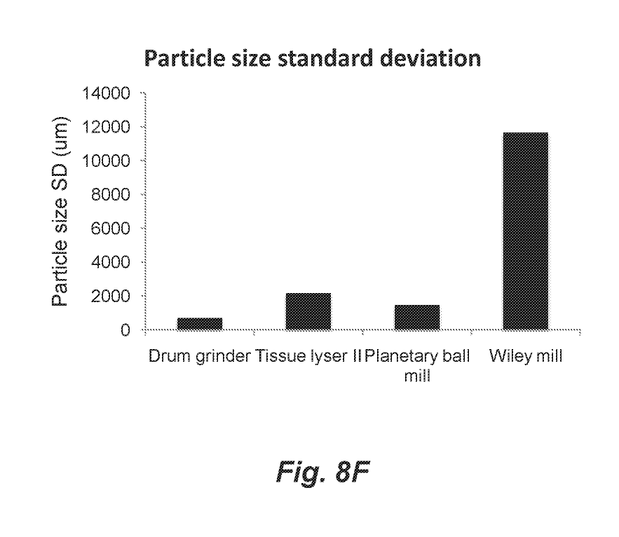

Referring to FIGS. 8A to 8F, this comparative data from Tables 1 to 3 represented in column chart form, where the reference to the “drum grinder” again refers to the method 1 and grinding apparatus 19 according to the embodiments of the invention. FIG. 8A shows the set up cost comparison, FIG. 8B shows the maintenance cost comparison, FIG. 8C shows the labour cost per sample comparison and FIG. 8D shows the cost per sample comparison. Thus, it can be seen that the embodiments of the invention confer significant cost, labour and maintenance savings compared to the other grinding techniques. Similarly, the embodiments of the invention also produce samples that have a smaller particle size, as indicated by FIG. 8E showing the particle size comparison, and are more homogenous (i.e. more consistent particle size, meaning less variance in particle size), as indicated by FIG. 8F showing the particle size standard deviation comparison, compared to the other grinding techniques.

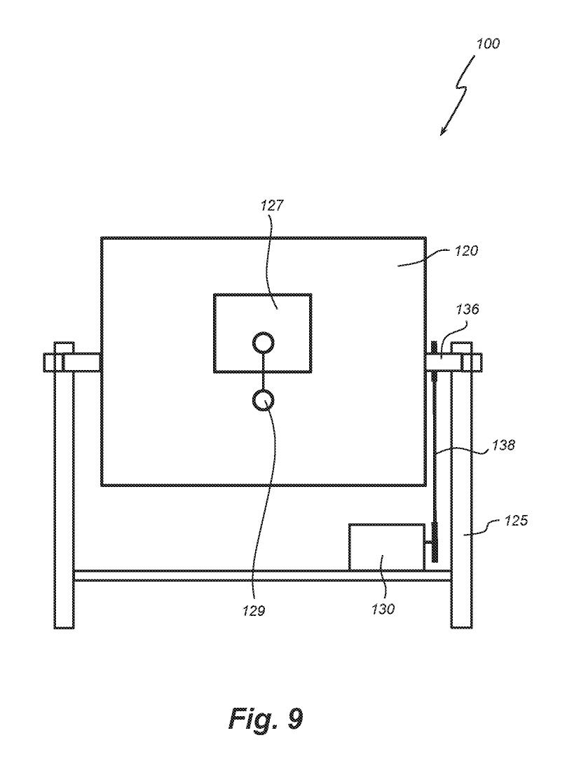

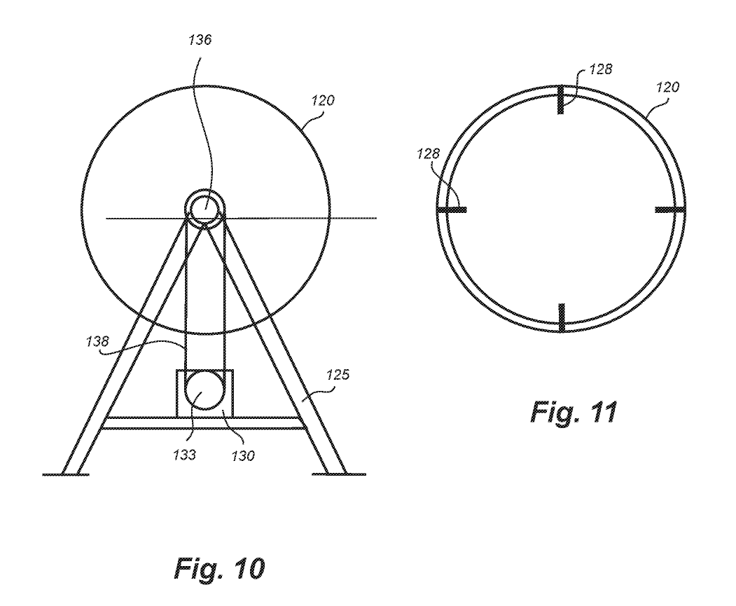

A further embodiment of a grinding apparatus 100 for use in the system according to the invention is illustrated in FIGS. 9 to 11. The grinding apparatus 100 comprises a rotatable cylinder or drum 120 mounted on a stand 125. The drum 120 has an access hatch 127, internal rubber agitating blades 128 and a handle 129. The access hatch 127 is opened and closed by the handle 129 to permit the containers 10 (having the samples 15 and grinding media 18 and/or 68) to be placed inside and removed from the drum 120. An electric motor 130 has a drive shaft 133 that is operably connected to the drive shaft 136 of the drum 120 via a drive chain 138. The grinding apparatus 100 operates in substantially the same manner as the apparatus 19 of FIG. 3.

While the preferred embodiments of the invention have been described with reference to grinding multiple samples, it will be appreciated that the invention is applicable to the grinding of at least two samples 15 in individual containers 10. In addition, the rotatable body can take a number of forms besides a drum 20, such as a spherical body or other polyhedral shape, such as prismatic (rectangular or cubic), octahedral, hexahedral, ovoid or other irregular polyhedral shape. Likewise, the containers 10 are not limited to cylindrical vials, but can adopt different polyhedral shapes as described above.

Furthermore, the invention is not limited to the above described rotatable body but may also be implemented using a movable body to receive the containers so as to impart motion to the containers and subject them to at least gravitational force or other forces to cause the grinding media in the containers to grind the samples/batches therein. In other embodiments of the invention, the containers may be placed within a holding container from which they are removed and imparted motion to cause the grinding action. For example, in one embodiment (not shown), the containers 10 are placed into a chamber or vessel (open or closed) and a screw conveyer is arranged vertically or at an angle to convey the containers 10 from the bottom of the screw conveyor to the top, from which the containers fall back into the vessel, subjecting them to gravitational force so as to induce grinding of the samples in the containers. In another embodiment (not shown), the containers 10 are placed into an open holding receptacle or container, from which a conveyor arranged at an angle to move the containers upwards along the conveyor belt from which they also fall back into the holding container, again subjecting them to gravitational force so as to induce grinding of the samples in the containers. In both of these embodiments, the containers 10 are moved to an elevation position and then permitted to fall to subject them to gravitational force and induce the grinding action without being subjected to rotational forces. Moreover, other forces may be applied to the containers to assist in the grinding action of the grinding media.

Since each sample is confined to one container, it is possible with the invention to prepare different types of samples at the same time. Thus, in other embodiments, some samples may comprise plant material while other samples comprise animal material, but are ground at the same time in their individual containers. In this embodiment, the containers would be labelled to ensure that there is no confusion as to which type of sample is present in the containers.

In some embodiments, the grinding media 18, 68 is substantially composed of a ferrous material to enable the grinding media to be readily removed from the containers 10 after the samples 15 have been ground. The grinding media 18, 68 may have a ferrous core surrounded by other non-ferrous material or be entirely composed of ferrous material; i.e. be homogenously ferrous throughout the grinding media. In these embodiments, a magnetic force would be applied to the container 10 to extract the grinding media and leave the ground sample 15. The magnetic force can be generated using any suitable magnetic source, such as a magnet or electromagnet.

In some embodiments, where the movable body is not a rotatable body other drive mechanisms may be used. For example, it is contemplated that the movable body It should also be appreciated that while the embodiments of the invention have been described as using plant material as the samples to be prepared, the method and system of the invention are readily applicable to samples composed of other materials, including both biological and inorganic materials. For example, the method and system may be used to prepare samples of other biological material, including biomass, animal tissue, microbiological material, genetic material (animal or plant based), food, and pharmaceutical substances. Examples of inorganic materials include mineral ores, rocks, metals, plastics, glass, ceramics and inorganic chemicals.

It will further be appreciated that any of the features in the preferred embodiments of the invention can be combined together and are not necessarily applied in isolation from each other. For example, there may be different types of grinding media 18, 68 used in combination with grinding media being made of ferrous material to assist extraction from the containers 10. Similar combinations of two or more features from the above described embodiments or preferred forms of the invention can be readily made by one skilled in the art.

It can thus be seen from the description of the preferred embodiments that the invention confers numerous advantages over the prior art. By enabling multiple samples to be ground simultaneously, yet separately from each other, the sample preparation process is more efficient in that more samples can be prepared in less time compared to existing grinding apparatuses. Since the samples are kept in their own containers, there is no need to clean the grinding apparatus, unlike conventional grinders. This saves time and labour in thoroughly cleaning the grinding apparatus, allowing more time for productive tasks in the laboratory. The invention also minimises the risk of contamination of the samples as they are kept in their containers, ready for testing. In addition, by placing and preparing the samples 15 in individual containers 10, the invention enables the prepared samples 15 to be immediately used for testing or alternatively conveniently stored in the containers 10 for future use, testing or transport to another testing facility or laboratory without having to handle and thus potentially contaminate the samples. Furthermore, it has been discovered that the samples prepared in accordance with embodiments of the invention have a smaller particle size and thus produce more accurate results when subject to testing. This improves the accuracy of measurements and the quality of testing. A further advantage of the invention is that the method and system facilities automation of sample preparation, as the grinding apparatuses 19, 50, 100 can be left in operation overnight without constant monitoring, as required in existing grinding apparatuses. Yet another advantage of the invention is that the method and system are readily scalable to suit sample size and enable either mass preparation of samples or a more discrete number of samples. Moreover, these advantages of the invention are not limited to the preparation of samples for testing, but may also be achieved more generally in the grinding of batches of material for various other purposes. In particular, the benefits of simultaneously grinding separate batches of material (that may have the same or different substances in each container) and reducing contamination are applicable to the grinding and processing of other materials. Thus, in all these respects, the invention represents a practical and commercially significant improvement over the prior art.

Although the invention has been described with reference to specific examples, it will be appreciated by those skilled in the art that the invention may be embodied in many other forms.

1. A method for grinding two or more batches of material, comprising placing a first batch into a first container and placing a second batch into a second container; adding a grinding media in each of said first and second containers; and moving said first and second containers so that said grinding media grind said first and second batches inside their respective first and second containers.

2. The method of claim 1, further comprising placing said first and second containers into a holding container, elevating said first and second containers from said holding container and permitting said first and second containers to fall back into said holding container to subject said first and second containers to a gravitational force to cause grinding of said first and second batches.

3. The method of claim 1, further comprising placing said first and second containers into a movable body and moving said movable body to impart motion to said first and second containers to subject said first and second containers to a gravitational force.

4. The method of claim 3, wherein said movable body comprises a rotatable body, the method further comprising rotating said rotatable body to induce rotation of said first and second containers in said rotatable body.

5. (canceled)

6. The method of claim 1, further comprising drying said first and second batches prior to moving said first and second containers.

7. The method of claim 6, wherein said first and second batches are dried after placement into said first and second containers.

8. The method of claim 6, wherein said first and second containers are sealed after drying.

9. The method of claim 6, wherein said drying of said first and second batches occurs at a temperature of around 40° C. to 100° C.

10. The method of claim 3, further comprising placing said movable body in a low temperature environment, wherein said low temperature environment is between 5° C. and −200° C. or between −40° C. and −60° C.

11. (canceled)

12. (canceled)

13. The method of claim 1, further comprising removing said grinding media from said first and second containers, wherein said grinding media comprises a ferrous material and said method further comprises using a magnetic force to remove said grinding media from said first and second containers.

14. (canceled)

15. The method of claim 1, said grinding media comprises at least two different types of grinding media to enhance grinding of said first and second batches.

16. The method of claim 1, further comprising retaining said first and second batches in said first and second containers for subsequent processing, wherein said subsequent processing comprises at least one of transportation of said first and second batches, storage of said first and second batches and testing said first and second batches.

17.-23. (canceled)

24. The method of claim 1, wherein there is a plurality of batches and containers, wherein each batch is placed into a separate container.

25. (canceled)

26. A method for preparing two or more samples for laboratory testing, comprising placing a first sample into a first container and placing a second sample into a second container; adding a grinding media in each of said first and second containers; placing said first and second containers into a rotatable body; and rotating said rotatable body to induce rotation of said first and second containers in said rotatable body so that said grinding media grind said first and second samples inside their respective first and second containers.

27. Use of two or more containers in the method of claim 1.

28. The use of the two or more containers of claim 27, wherein said containers comprise at least one of an impact resistant material and a heat and cold resistant material.

29. (canceled)

30. A system for preparing two or more batches of material, comprising two or more containers for receiving said batches and a grinding media, a holding container for receiving said containers, a drive mechanism for moving said containers so that said grinding media grinds said batches inside said containers.

31. (canceled)

32. The system of claim 30, wherein said holding container comprises a rotatable body and said drive mechanism is operable to rotate said rotatable body to induce rotation of said containers.

33. (canceled)

34. The system of claim 30, said system further comprises a chamber for receiving said movable body, wherein said chamber is configured to produce a low temperature environment around said movable body to cool said batches inside said containers.

35. The system of claim 30, further comprising a heating device for heating said containers prior to placement in said holding container or movable body.

36. (canceled)
